(19) United States
(12) Patent Application Publication
(10) Pub. No.: US 2019/0342737 A1
(43) Pub. Date: Nov. 7, 2019

(54) REMOTE BLUETOOTH COMMUNICATION SYSTEM

(71) Applicant: Linctronix Ltd., New Taipei City (TW)

(72) Inventors: Yu-Shun LIN, New Taipei City (TW); Kuei-Han CHEN, New Taipei City (TW); Min-Sung JAO, New Taipei City (TW)

(21) Appl. No.: 16/397,878

(22) Filed: Apr. 29, 2019

(30) Foreign Application Priority Data
May 4, 2018 (TW) 107115331

(51) Int. Cl. H04W 4/80; H04L 12/24

(52) U.S. Cl. CPC H04W 4/80; H04W 88/16; H04L 41/22

(57) ABSTRACT

A remote Bluetooth communication system of the present invention comprises a Bluetooth gateway, a Bluetooth device, a cloud virtual device and a Bluetooth application program. The Bluetooth device is configured in a service area of the Bluetooth gateway. The cloud virtual device further includes a Bluetooth virtual layer module and a communication module. The Bluetooth virtual layer module is configured for providing a Bluetooth interface. The communication module is configured for establishing a network communication with the Bluetooth gateway. The Bluetooth application program is executed on the cloud virtual device for controlling the Bluetooth device in the service area of the Bluetooth gateway in the service area of the Bluetooth gateway through the Bluetooth interface provided by the Bluetooth virtual layer module. The invention can solve the problems of consuming the network traffic, memory space and resources of mobile phone processor.

### CROSS-REFERENCE TO RELATED APPLICATIONS

The present application is based on, and claims priority from, Taiwan Patent Application No. 107115331, filed on May 4, 2018, the disclosure of which is hereby incorporated by reference herein in its entirety.

### BACKGROUND OF THE INVENTION

### Field of the Invention

The present invention provides a Bluetooth connection system, and more particularly, provides a remote Bluetooth connection system that uses a cloud virtual device to simulate a mobile phone to execute a Bluetooth application program and then operates a Bluetooth device remotely through a Bluetooth gateway.

### Description of the Prior Art

Bluetooth wireless transmission technology is one of the most widely used short distance wireless transmission standards in the world. The Bluetooth version 4.0 communication protocol introduced in the year 2010 covers three Bluetooth communication protocols, namely combining traditional Bluetooth communication protocol, high-speed Bluetooth communication protocol, and low-power Bluetooth communication protocol into one. It inherits the inherent advantages of the features of high-speed Bluetooth and low-power Bluetooth of Bluetooth technology in wireless connectivity. These three specifications can be combined or used separately. The core technology of the Bluetooth version 4.0 communication protocol is low energy, namely the Bluetooth 4.0 BLE communication protocol. The technology is characterized by ultra-low operating power consumption and standby power consumption. Bluetooth low-power devices can operate continuously for several years even with a button-type battery. The Bluetooth version 4.0 communication protocol also includes features of low cost, high stability, fast connection and high security.

Although there are many advantages of Bluetooth wireless transmission technology as mentioned above, in practices, the Bluetooth devices for different purposes require different Bluetooth application layer communication protocols, so that each kind of Bluetooth devices is supported by different combinations of communication protocols respectively, and the application programs (APPs) corresponding to the Bluetooth devices respectively are derived.

In the prior art, the Bluetooth device suppliers upload the APPs to a web application store and provide them to consumers for installation in their mobile phone. However, consumers need to install different APPs for operating different Bluetooth devices. Downloading the APPs will result in the occupation of the network traffic and the memory space of the mobile phone, and using the APPs will consume resources of mobile phone processor. The APPs need to be manually operated to run on the mobile phones, and it will be extremely inconvenient because the APPs are unable to be automatically operated for a long time.

### SUMMARY OF THE INVENTION

In response to the above-mentioned problems, an objective of the present invention is to provide a virtual device in cloud to simulate a mobile phone executing an APP provided from suppliers. The APP provided from suppliers is usually set to communicate with a Bluetooth device through a Bluetooth communication module instead of a network communication. Therefore, the present invention is intended to build on a system that can be remotely controlled without changing the APP.

A remote Bluetooth communication system of the present invention comprises a Bluetooth gateway, a Bluetooth device, a cloud virtual device and a Bluetooth application program. The Bluetooth device is configured in a service area of the Bluetooth gateway. The cloud virtual device further includes a Bluetooth virtual layer module and a communication module. The Bluetooth virtual layer module is configured for providing a Bluetooth interface. The communication module is configured for establishing a network communication with the Bluetooth gateway. The Bluetooth application program is executed on the cloud virtual device for controlling the Bluetooth device in the service area of the Bluetooth gateway or reading a value measured by the Bluetooth device in the service area of the Bluetooth gateway through the Bluetooth interface provide by the Bluetooth virtual layer module and the network communication. The network communication can be Bluetooth, wired networks, wireless local area networks, or mobile communication networks.

In an embodiment, the Bluetooth device is a Bluetooth physiological information measuring device, a Bluetooth environment sensing device or a Bluetooth control device.

In an embodiment, the Bluetooth interface is a Bluetooth application programming interface, a Bluetooth library interface, a Bluetooth system call interface or a Bluetooth driver interface.

In an embodiment, the cloud virtual device is running on a cloud server that executes an operating system by using a virtual device simulator, and the operating system is an Android operating system, an iOS operating system, Linux, or other operating systems of mobile devices.

In an embodiment, the Bluetooth virtual layer module encapsulates a Bluetooth virtual instruction set when the Bluetooth interface calls and then transmits the Bluetooth virtual instruction set to the Bluetooth gateway via the network communication. The Bluetooth gateway communicates with Bluetooth device according to the Bluetooth virtual instruction set.

In an embodiment, the Bluetooth virtual instruction set is the instruction set comprising HCI, GATT, L2CAP or any other Bluetooth protocol.

In an embodiment, the Bluetooth gateway comprises a network module, a communication layer module, and a Bluetooth module. The communication layer module communicates with the communication module by the network module and parses the Bluetooth virtual instruction set, and the communication layer module communicates with the Bluetooth device through the Bluetooth module according to the Bluetooth virtual instruction set.

In an embodiment, the network module and the communication module are wired networks, wireless local area networks, or mobile communication networks.

In an embodiment, the Bluetooth virtual layer module encapsulates the Bluetooth virtual instruction in a first virtual network packet via a universal asynchronous transceiver based on a TCP proxy (UART over TCP proxy), and the communication layer module parses the first network packet through the universal asynchronous transceiver to obtain the Bluetooth virtual instruction set.

In an embodiment, the remote Bluetooth communication system of the present invention further comprises an intelligent terminal connected to the cloud virtual device and configured for displaying a display interface of the Bluetooth application program to control the Bluetooth device.

In summary, the remote Bluetooth communication system of the present invention simulates the mobile phone installing and executing the Bluetooth application program on the mobile phone via the cloud virtual device. Therefore, the remote Bluetooth communication system can solve the problems of consuming the network traffic, memory space and resources of mobile phone processor. The remote Bluetooth communication system via the Bluetooth virtual layer module provides the Bluetooth virtual instruction set required for the Bluetooth gateway to communicate with the Bluetooth device, and implements the remote operation of the Bluetooth device by the cloud virtual device through the Bluetooth gateway. In particular, the cloud virtual device executed on the cloud server can be set to automatically communicate with the Bluetooth device without human intervention. In addition, multiple users can log in to the cloud server using different intelligent terminals to operate the Bluetooth device with the same Bluetooth application program.

### BRIEF DESCRIPTION OF THE APPENDED DRAWINGS

Some of the embodiments will be described in detail, with reference to the following figures, wherein like designations denote like members, wherein:

FIG. 1 is a function block diagram illustrating remote Bluetooth communication system according to an embodiment the present invention.

FIG. 2 is a functional block diagram illustrating the remote Bluetooth communication system according to another embodiment the present invention.

FIG. 3 is a functional block diagram illustrating the remote Bluetooth communication system according to another embodiment the present invention.

FIG. 4 is a functional block diagram illustrating the remote Bluetooth communication system according to another embodiment the present invention.

The advantages, spirits, and features of the present invention will be explained and discussed with embodiments and figures as follows.

### DETAILED DESCRIPTION OF THE INVENTION

A detailed description of the hereinafter described embodiments of the disclosed apparatus and method are presented herein by way of exemplification and not limitation with reference to the Figures. Although certain embodiments are shown and described in detail, it should be understood that various changes and modifications can be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

In the description of the present specification, the terminologies “in an embodiment”, “in another embodiment”, or “in some embodiments” means that the specific feature, structure, material or characteristic of the present embodiment is involved in at least one embodiment of the present invention. In the description of the present specification, the schematic representation of the mentioned terminologies does not necessarily refer to the same embodiment. Furthermore, the described specific feature, structure, material or characteristic can be involved in any one or more embodiments in a proper way.

In the embodiments of the present specification, the terminology “or” includes the combination of part of listed components, and the combination of all the listed components. For example, the described “A or B” includes only A, only B, and both A and B. Moreover, the terminologies “a” and “the” before the element or component of the present invention do not limit the number of element or component. Therefore, the terminologies “a” and “the” should be read as including one or at least one. Besides, the singular form of element or component also includes the plural form, unless the number clearly refers to the singular form.

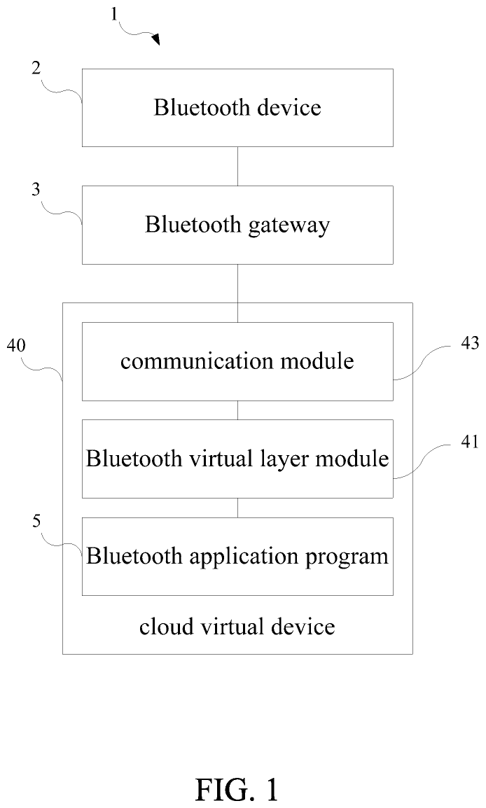

Please refer to FIG. 1. FIG. 1 is a functional block diagram illustrating a remote Bluetooth communication system 1 according to an embodiment the present invention. The remote Bluetooth communication system 1 of the present invention comprises a Bluetooth gateway 3, a Bluetooth device 2, a cloud virtual device 40 and a Bluetooth application program 5. The Bluetooth device 2 is configured in a service area of the Bluetooth gateway 3. The cloud virtual device 40 further includes a Bluetooth virtual layer module 41 and a communication module 43. The Bluetooth virtual layer module 41 is configured for providing a Bluetooth interface. The communication module 43 is configured for establishing a network communication with the Bluetooth gateway 3. The Bluetooth application program 5 is executed on the cloud virtual device 40 for controlling the Bluetooth device 2 in the service area of the Bluetooth gateway 3 or reading a value measured by the Bluetooth device 2 in the service area of the Bluetooth gateway 3 through the Bluetooth interface provided by the Bluetooth virtual layer module 41 and the network communication.

In an embodiment, the Bluetooth device 2 is a Bluetooth physiological information measuring device, a Bluetooth environment sensing device or a Bluetooth control device. When the Bluetooth device 2 is located within the serves area of the Bluetooth gateway 3, the Bluetooth gateway 3 can establish a Bluetooth communication with the Bluetooth device 2.

In an embodiment, the Bluetooth interface is a Bluetooth application programming interface, a Bluetooth library interface, a Bluetooth system call interface or a Bluetooth driver interface.

In practice, the communication module 43 can be a physical communication module or a virtual communication module, and the cloud virtual device 40 can establish the network communication to the Bluetooth gateway 3 by the communication module 43 through the internet network or the internal network of the enterprise.

In practice, the Bluetooth application program 5 is the software used by the Bluetooth device 2. In the prior art, the Bluetooth application program 5 is usually provided by Bluetooth device suppliers and is uploaded to an online application store for the user to download into the mobile phone. In the present invention, the user downloads the Bluetooth application program 5 to the cloud virtual device 40, and the cloud virtual device 40 replaces the mobile phone to execute the program to operate the Bluetooth device 2. Therefore, the problem of consuming the network traffic, memory space and resources of mobile phone processor is solved when installing the application into the mobile phone. Moreover, there is no need to rewrite the content of the application program provided by the suppliers.

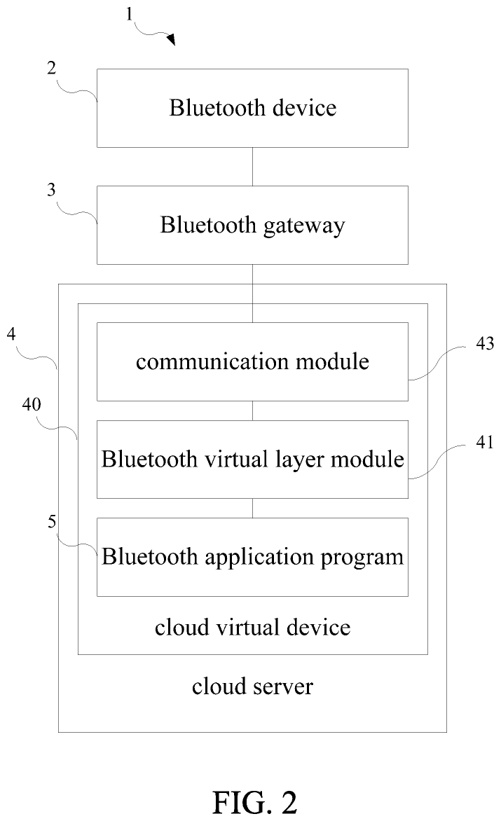

Please refer to FIG. 2. FIG. 2 is a functional block diagram illustrating the remote Bluetooth communication system 1 according to another embodiment the present invention. In an embodiment, the cloud virtual device 40 is running on a cloud server 4 that executes an operating system by using a virtual device simulator. In practice, the operating system can be, but not limit to, an Android operating system, an iOS operating system, Linux, or other operating systems of mobile devices. In practice, the virtual device simulator can be, but not limited to, QEMU, XEN, Hyper-V, Open VZ, Oracle VM, Pear PC, Virtuozzo, VMware Server, DOSBox or KVM etc.

In an embodiment, the Bluetooth virtual layer module 41 encapsulates a Bluetooth virtual instruction set when the Bluetooth interface calls and then transmits the Bluetooth virtual instruction set to the Bluetooth gateway 3 via the network communication, and the Bluetooth gateway 3 communicates with Bluetooth device 2 according to the Bluetooth virtual instruction set. In an embodiment, the Bluetooth virtual instruction set is the instruction set comprising HCI (Host Control Interface), GATT (Generic Attributes), L2CAP (Logical Link Control and Adaptation Protocol), GAP (General Access Profile), SDAP (Service Discovery Application Profile), SPP (Serial Port Profile), GOEP (General Object Exchange Profile), A2DP (Advance Audio Distribution Profile), HID (Human Interface Device), BLE (Bluetooth Low Energy), etc., or any other instruction sets, profile or communication interface specified by the Bluetooth protocol. The Bluetooth virtual instruction set can also be a programming language or a configuration file that describes the above-mentioned instruction set.

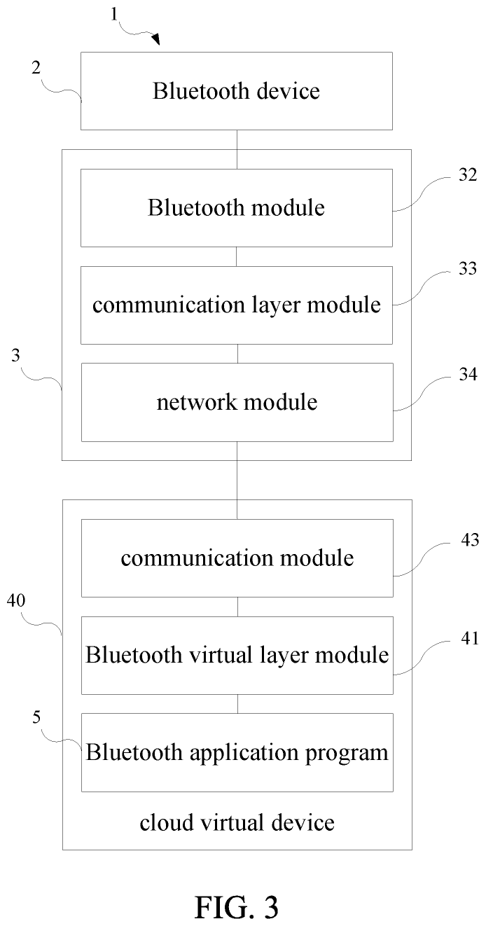

Please refer to FIG. 3. FIG. 3 is a functional block diagram illustrating the remote Bluetooth communication system 1 according to another embodiment the present invention. In an embodiment, the Bluetooth gateway 3 comprises a network module 34, a communication layer module 33, and a Bluetooth module 32. The communication layer module 33 communicates with the communication module 43 by the network module 34 and parses the Bluetooth virtual instruction set, and the communication layer module 33 communicates with the Bluetooth device 2 through the Bluetooth module 32 according to the Bluetooth virtual instruction set.

In an embodiment, the network module 34 and the communication module 43 utilize Bluetooth, wired networks, wireless local area networks, or mobile communication networks.

In an embodiment, the communication layer module 33 of the Bluetooth gateway 3 exchanges data with the communication module 43 through the network module 34, and transfers the data to the Bluetooth module 32 to complete the action under the Bluetooth communication protocol.

In an embodiment, the Bluetooth virtual layer module 41 encapsulates the Bluetooth virtual instruction in a first virtual network packet via a universal asynchronous transceiver based on a TCP proxy (UART over TCP proxy), and the communication layer module 33 parses the first network packet through the universal asynchronous transceiver to obtain the Bluetooth virtual instruction set. For example, the Bluetooth virtual layer module 41 encapsulates HCI communication information into TCP packet through UART over TCP Proxy, and communicates and exchanges the TCP packet information with the Bluetooth gateway 3 remotely through the communication module 43. The communication layer module 33 of the Bluetooth gateway 3 parses the HCI communication information through the UART over TCP proxy and transmits it to the Bluetooth module 32 to complete the exchange of the contents of HCI protocol.

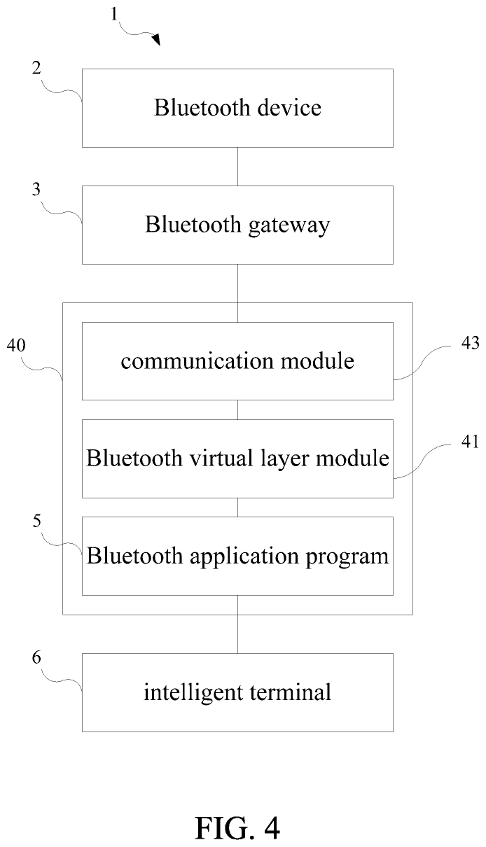

Please refer to FIG. 4. FIG. 4 is a functional block diagram illustrating the remote Bluetooth communication system 1 according to another embodiment the present invention. In an embodiment, the remote Bluetooth communication system 1 of the present invention further comprises an intelligent terminal 6 connected to the cloud virtual device 40 and configured for displaying a display interface of the Bluetooth application program 5 to control the Bluetooth device 2. After the intelligent terminal 6 is connected to the Bluetooth application program 5, a screen of the intelligent terminal 6 can display and output the display interface of the Bluetooth application program 5. Therefore, the user can remotely instruct the Bluetooth application program 5 to read or control the Bluetooth device 2 through an input interface of the intelligent terminal 6. In practice, the intelligent terminal 6 can be a smart phone, a tablet, a personal computer or an intelligent wearable device.

In an embodiment, the user can set the cloud server 4 so that the cloud server 4 automatically reads or controls the Bluetooth device 2 without receiving an instruction from the intelligent terminal 6. In another embodiment, the cloud server 4 can be logged in by multiple intelligent terminals, so that multiple users can read or control the Bluetooth device 2 separately.

Please refer to FIG. 1 again. In an embodiment, there is a Bluetooth physiological information measuring device located within the service area of the Bluetooth gateway 3. The Bluetooth physiological information measuring device includes a corresponding Bluetooth application program 5. The user downloads the Bluetooth application program 5 to the cloud virtual device 40. When the user measures physiological information, he/she connects to the cloud server 4 via a mobile phone to open the Bluetooth application program 5. The weight value measured by the user each time is stored in the Bluetooth application program 5 or the cloud server 4. When the user wants to view the change of the recent physiological information, he/she opens the Bluetooth application program 5 by the mobile phone connected to the cloud server 4 to know the change of the physiological information from the Bluetooth application program 5. The Bluetooth physiological information measuring device can be a weight scale, a blood pressure meter, an oximeter, an electrocardiogram measuring instrument, a somatosensory posture meter, a pedometer, a fall detector or any other physical information measuring device with a Bluetooth function.

In an embodiment, there is an air conditioner with Bluetooth function located in a room A and is within the service area of the Bluetooth gateway 3. The air conditioner includes a corresponding Bluetooth application program 5. The user downloads the Bluetooth application program 5 to the cloud virtual device 40 via the cloud server 4. The user connects to the cloud server 4 with a mobile phone in an area B and views the Bluetooth application program 5. The user reads the current temperature is 30 degrees in the room A measured by a built-in thermometer of the air conditioner through the Bluetooth application program 5. Then, the user controls the Bluetooth application program 5 running in the cloud virtual device 40 with the mobile phone to start the air conditioner.

In an embodiment, there is a monitor with Bluetooth function located within the service area of the Bluetooth gateway 3. The monitor includes a corresponding Bluetooth application program 5. The user downloads the Bluetooth application program 5 to the cloud virtual device 40 via the cloud server 4. The user sets the cloud virtual device 40 to control the Bluetooth application program 5 to turn on the monitor for a long time, and to store the image in the Bluetooth application program 5 or other storage space of the cloud virtual device 40.

In an embodiment, there is an audio equipment with Bluetooth function located within the service area of the Bluetooth gateway 3. The audio equipment includes a corresponding Bluetooth application program 5. The user downloads the Bluetooth application program 5 to the cloud virtual device 40 via the cloud server 4. The user sets the cloud virtual device 40 to connect to a cloud music database and play the music file stored in the cloud music database with the Bluetooth application program 5. Therefore, even if the corresponding Bluetooth application program 5 and music file are not installed in the user's mobile phone, the audio equipment with the Bluetooth function can play music even without turning on the Bluetooth function.

The Bluetooth of the above embodiments is any version of the Bluetooth protocol specification defined by the Bluetooth association. For example, various Bluetooth protocols defined by the Bluetooth 2.0 protocol series, the Bluetooth 3.0 protocol series, the Bluetooth 4.0 protocol series, or the Bluetooth 5.0 protocol series.

The wired network of the above embodiments can be an Ethernet network, a fiber-optic network (FTTx), a power line communication, etc., or the other wired networks which can transmit a network packet.

The wireless local area network of the above embodiments is any version of the 802.11 communication protocol specification defined by Wi-Fi or IEEE, for example, 802.11, IEEE 802.11a, 802.11b, 802.11g, 802.11h, 802.11n, 802.11p, 802.11ac, 802.11ah, 802.11aq, 802.11ax, etc.

The mobile communication network of the above embodiments can be the agreement network of Release 4, Release 5, Release 6, Release 7, Release 8, Release 9, Release 10, Release 11, Release 12, Release 13, Release 14 which are published by LoRa, Sigfox, NBloT or 3GPP association, or the other mobile protocol networks approved by other ITU international telecommunications union.

Compare to the prior art, the remote Bluetooth communication system 1 of the present invention simulates the mobile phone installing and executing the Bluetooth application program 5 on the mobile phone via the cloud virtual device. Therefore, the remote Bluetooth communication system 1 can solve the problems of consuming the network traffic, memory space and resources of mobile phone processor. The remote Bluetooth communication system 1 via the Bluetooth virtual layer module 41 provides the Bluetooth virtual instruction set required for the Bluetooth gateway 3 to communicate with the Bluetooth device 2, and implements the remote operation of the Bluetooth device by the cloud virtual device through the Bluetooth gateway 3. In particular, the cloud virtual device 40 executed on the cloud server 4 can be set to automatically communicate with the Bluetooth device 2 without human intervention. In addition, multiple users can log in to the cloud server 4 using different intelligent terminals 6 to operate the Bluetooth device 2 with the same Bluetooth application program 5.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A remote Bluetooth communication system, comprising:
a Bluetooth gateway;
a Bluetooth device configured in a service area of the Bluetooth gateway;
a cloud virtual device including:
a Bluetooth virtual layer module configured for providing a Bluetooth interface; and
a communication module configured for establishing a network communication with the Bluetooth gateway; and
a Bluetooth application program executed on the cloud virtual device, the Bluetooth application program being configured for controlling the Bluetooth device in the service area of the Bluetooth gateway or reading a value measured by the Bluetooth device in the service area of the Bluetooth gateway through the Bluetooth interface by the Bluetooth virtual layer module.

2. The remote Bluetooth communication system of the claim 1, wherein the Bluetooth virtual layer module encapsulates a Bluetooth virtual instruction set when the Bluetooth interface calls and then transmits the Bluetooth virtual instruction set to the Bluetooth gateway via the network communication, and the Bluetooth gateway communicates with the Bluetooth device according to the Bluetooth virtual instruction set.

3. The remote Bluetooth communication system of the claim 2, wherein the Bluetooth virtual instruction set is the instruction set comprising HCI, GATT, L2CAP or any other Bluetooth protocol.

4. The remote Bluetooth communication system of the claim 2, wherein the Bluetooth gateway comprises a network module, a communication layer module, and a Bluetooth module; the communication layer module communicates with the communication module and parses the Bluetooth virtual instruction set by the network module, and the communication layer module communicates with the Bluetooth device through the Bluetooth module according to the Bluetooth virtual instruction set.

5. The remote Bluetooth communication system of the claim 4, wherein the network module and the communication module utilize wired networks, wireless local area networks, or mobile communication networks.

6. The remote Bluetooth communication system of the claim 4, wherein the Bluetooth virtual layer module encapsulates the Bluetooth virtual instruction in a first virtual network packet via a universal asynchronous transceiver (UART over TCP proxy) based on a TCP proxy, and the communication layer module parses the first network packet through the universal asynchronous transceiver to obtain the Bluetooth virtual instruction set.

7. The remote Bluetooth communication system of the claim 1, wherein the Bluetooth interface is a Bluetooth application programming interface, a Bluetooth library interface, a Bluetooth system call interface or a Bluetooth driver interface.

8. The remote Bluetooth communication system of the claim 1, wherein the cloud virtual device is running on a cloud server that executes an operating system by using a virtual device simulator, and the operating system is an Android operating system, an iOS operating system, Linux, or other operating systems of mobile devices.

9. The remote Bluetooth communication system of the claim 1, further comprising an intelligent terminal connected to the cloud virtual device and configured for displaying a display interface of the Bluetooth application program to control the Bluetooth device.

10. The remote Bluetooth communication system of the claim 1, wherein the Bluetooth device is a Bluetooth physiological information measuring device, a Bluetooth environment sensing device or a Bluetooth control device.
